(19) United States
(12) Patent Application Publication
(10) Pub. No.: US 2002/0143893 A1
(43) Pub. Date: Oct. 3, 2002

(54) Information processing apparatus, information processing method, program, and storage medium product for distribution of image forming control software

(76) Inventors: Yusuke Nakazono, Shizuoka (JP); Yasumasa Ohtsuka, Shizuoka (JP); Kengo Kawamoto, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/029,291

(22) Filed: Dec. 28, 2001

(30) Foreign Application Priority Data
Dec. 28, 2000 (JP) 402944/2000(PAT.)
Dec. 14, 2001 (JP) 381590/2001(PAT.)

(51) Int. Cl. G06F 15/16; G03G 21/14

(52) U.S. Cl. 709/217; 399/77

(57) ABSTRACT

A distribution server made up of an image forming apparatus manager and a host computer is provided to be capable of communicating with an image forming apparatus via a network. The distribution server comprises a receiving unit for receiving identifying information of a consumable unit, which is detachably loaded in the image forming apparatus, and a software distributing unit for transmitting image formation control software to the image forming apparatus depending on the received identifying information of the consumable unit.

### BACKGROUND OF THE INVENTION

1. Field of the Invention

The present invention relates to an information processing apparatus, an information processing method, a program, and a storage medium product, which are useful for distribution and management of image forming control software used in image forming apparatuses, such as electrophotographic copying machines and electrophotographic printers.

2. Description of the Related Art

In electrophotographic image forming apparatuses, such as laser beam printers and copying machines, it is desired that optimum software be always installed in each image forming apparatus for optimum control of the apparatus.

To meet such a demand, Japanese Patent Laid-open No. 05-73329 proposes an image forming apparatus wherein, when the status in usage of the apparatus reaches a predetermined situation, a request for transmission of the latest control program is sent to external equipment via a communication network interface, and the existing control program is automatically replaced by the latest one.

Also, Japanese Patent Laid-open No. 2000-267201 proposes a system wherein a version-up kit corresponding to each image forming apparatus is prepared by combining various versions of software necessary for various components based on device operating information, etc., and by determining a deviation from the predetermined operation based on print information and combining correction amounts of respective operation factors. The prepared software is distributed as an attached file of E-mail to the image forming apparatus from a remote location.

However, the above-described related art has problems as follows. One problem is that any of the conventional proposals cannot realize unified management of image formation control software in consideration of characteristics of a replaced consumable unit detachably loaded in the image forming apparatus, such as a process cartridge comprising a photoconductor as an image bearing member, a charging roller as a charging means, a toner as a developer, a developing roller as a developer carrier, etc., which are assembled together into an integral unit.

More specifically, the above-described related art is able to realize update control of the image formation control software depending on operating information of the image forming apparatus itself, such as the number of times of operations of the apparatus, but it has not been proposed in consideration of image formation control software corresponding to a consumable part detachably loaded in a body of the image forming apparatus. For example, in the case of loading a new process cartridge in a certain image forming apparatus, unless control software installed in a body of that image forming apparatus is updated, image formation control software optimum for the newly loaded process cartridge cannot be realized.

In some of image forming apparatuses, the same type of consumable unit is utilized in spite of apparatus bodies being of the different types. However, software distribution depending on combinations of the types (characteristics) of those image forming apparatuses and the types of consumable units has not been taken into consideration in the related art.

It is known that characteristics of an image forming apparatus and various consumable parts used in the image forming apparatus change depending on the operating status. Further, even apparatuses and parts having the same types (models) often change dynamic characteristics in different ways depending on the operating status if their production lots are different from each other. The optimum use of image formation control software adapted for changes in dynamic characteristics, which differ from each other depending on the production lots, has also not been taken into consideration in the related art.

Furthermore, it is usual that a consumable unit or part used in an image forming apparatus is frequently replaced whenever its service life is expired. However, if users must pay attention to update of software each time the service life of the consumable unit is expired, this would impose troublesome work on the users. For that reason, there has been a demand for a system capable of executing update of optimum image formation control software in an efficient way when the consumable unit is replaced.

### SUMMARY OF THE INVENTION

With the view of overcoming the above-described problems in the related art, it is an object of the present invention to provide a system capable of supplying, to an image forming apparatus, optimum image formation control software depending on information of a consumable unit detachably loaded in the image forming apparatus.

Another object of the present invention is to provide a system for distributing image formation control software, which enables high-quality image formation to be always carried out regardless of the production lot and the operating status of a consumable unit

Still another object of the present invention is to provide a system capable of updating optimum image formation control software at the timing efficient for replacement of each part of a consumable unit that is detachably loaded in a body of an image forming apparatus.

Still another object of the present invention is to provide a system capable of updating optimum image formation control software depending on the type of an image forming apparatus and the type of a consumable unit that is detachably loaded in the image forming apparatus.

According to one aspect of the present invention, for providing a system capable of supplying, to an image forming apparatus, optimum image formation control software depending on information of a consumable unit detachably loaded in the image forming apparatus, an information processing apparatus is constructed as follows.

In an information processing apparatus for distributing image formation control software via a network, the apparatus comprises a receiving unit for receiving consumable-unit information regarding a consumable unit, which is detachably loaded in an image forming apparatus, from external equipment capable of communicating data via the network; and a software distributing unit for distributing image formation control software to the external equipment depending on the consumable-unit information via the network.

Alternatively, the information processing apparatus comprises a transmitting unit for transmitting consumable-unit information regarding a consumable unit, which is detachably loaded in an image forming apparatus, to an image-formation control software distribution server capable of communicating data via a network; and a receiving unit for receiving, via the network, image formation control software decided by and transmitted from the distribution server depending on the consumable-unit information.

More preferably, the information processing apparatus further comprises a recognizing unit for recognizing the consumable-unit information regarding the consumable unit detachably loaded in the image forming apparatus; a determining unit for determining whether the consumable-unit information recognized by the recognizing unit is changed from consumable-unit information stored in a predetermined storage unit; and a control unit for making control to display a prompt for updating the image formation control software when the determining unit determines that the consumable-unit information is changed.

According to another aspect, the present invention provides an image-formation control software distributing system made up of a first information processing apparatus for distributing image formation control software via a network, and a second information processing apparatus capable of executing communication with the first information processing apparatus, wherein the system comprises a receiving unit for receiving consumable-unit information regarding a consumable unit, which is detachably loaded in an image forming apparatus, from the second information processing apparatus capable of communicating data via the network; and a software distributing unit for distributing image formation control software to the first information processing apparatus depending on the consumable-unit information via the network.

Further objects, features and advantages of the present invention will become apparent from the following description of the preferred embodiments with reference to the attached drawings.

### BRIEF DESCRIPTION OF THE DRAWINGS

FIG. 1 is a block diagram of an overall distribution system according to a first embodiment of the present invention.

FIG. 2 is a schematic sectional view of an image forming apparatus in the first embodiment of the present invention.

FIG. 3 is a schematic view of a process cartridge loaded in the image forming apparatus.

FIG. 4 is a table for explaining the contents stored in a memory of the process cartridge.

FIG. 5 is a block diagram showing a schematic configuration of an image forming apparatus and a computer, which constitute the distribution system.

FIG. 6 is a flowchart showing processing executed in the image forming apparatus.

FIG. 7 is a flowchart showing processing executed in a distribution server.

FIG. 8 is a table for explaining one example of data managed as a database in the distribution server.

FIG. 9 is a graph showing a difference in photoconductor characteristics depending on the production lot.

FIG. 10 is a graph showing a difference in charging roller characteristics depending on the production lot.

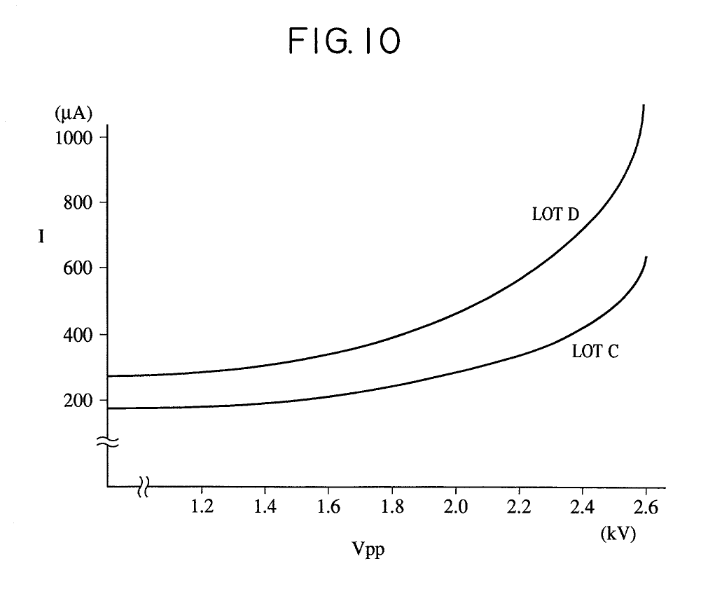

FIG. 11 is a flowchart showing processing executed in the distribution server.

FIG. 12 is a chart showing a cartridge assembly flow in a second embodiment of the present invention.

FIG. 13 is a conceptual diagram of an overall distribution system according to the second embodiment of the present invention.

FIG. 14 is a flowchart showing processing executed in a distribution server.

FIG. 15 shows one example of a display screen for prompting update of image formation control software.

FIG. 16 is a flowchart showing processing of image formation control software executed in the distribution server in accordance with ID information of an image forming apparatus, information of a consumable unit, and the operating status of the image forming apparatus.

FIG. 17 is a table showing one example of a database managed in the distribution server.

### DESCRIPTION OF THE PREFERRED EMBODIMENTS

Preferred embodiments of the present invention will be described below in detail, by way of example, with reference to the drawings. It is however to be noted that the following embodiments are not purported to limit the scope of the present invention to the constructions thereof unless so particularly specified.

It is also to be noted that the following description of a distribution system for image formation control software according to each embodiment of the present invention also provide descriptions of embodiments of a distribution server, a distribution method, a distribution program, a storage medium product storing the distribution program, an image forming apparatus, and an image formation control method in accordance with the present invention.

(First Embodiment)

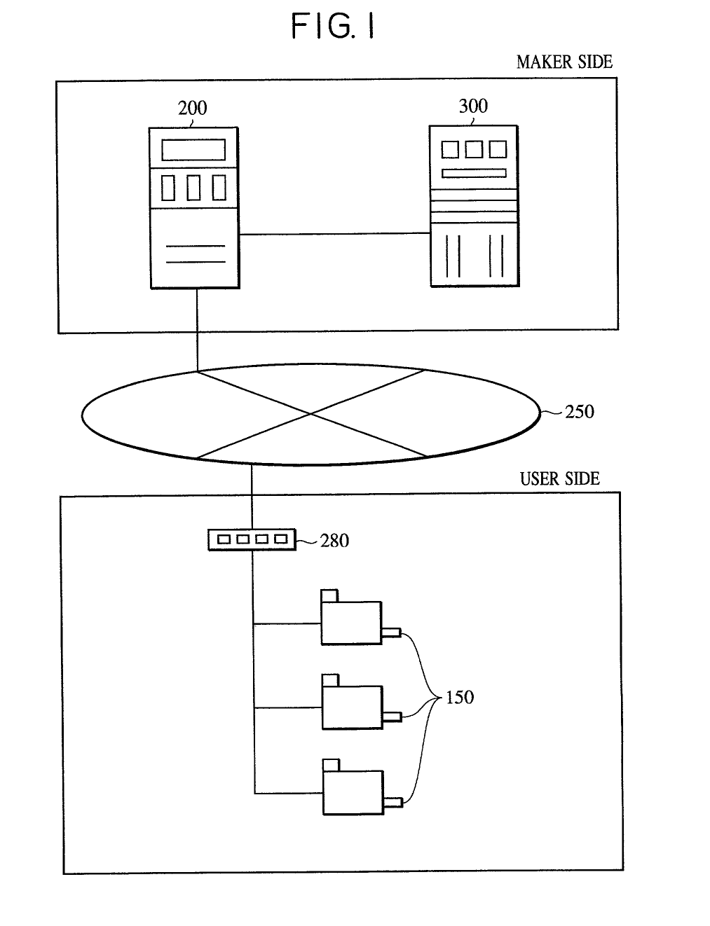

A distribution system according to a first embodiment of the present invention will be described with reference to the drawings. FIG. 1 shows an overall distribution system according to the first embodiment. The maker side and the user side are interconnected via a public line 250 for mutual communication. The objects of the present invention can be achieved so long as the public line 250 is a predetermined communication line capable of communicating data between the maker side and equipment installed on the user side. Therefore, the public line 250 may be, e.g., a telephone line, a digital line, or a radio communication line utilizing a digital electric wave. The term “maker side” used herein means a party managing an information processing apparatus that has at least the function of distributing image formation control software described in the following embodiment.

On the maker side, an image forming apparatus manager 200 for managing a plurality of or one image forming apparatus on the user side and a host computer 300 are interconnected via a network. In this embodiment, the image forming apparatus manager 200 and the host computer 300 constitute a distribution server. The image forming apparatus manager 200 and the host computer 300 may be constructed by a single piece of equipment for achieving the objects of the present invention.

On the user side, a plurality of image forming apparatuses 150 and a communication adapter 280 are interconnected via a network for mutual communication. The communication adapter 280 may be a local server having at least the function of communication with external equipment via a network. As a more preferable embodiment, the image forming apparatus 150 may be modified to have the function of communication with external equipment via the Internet. This arrangement eliminates the need of providing the communication adapter 280 separately from the image forming apparatus 150.

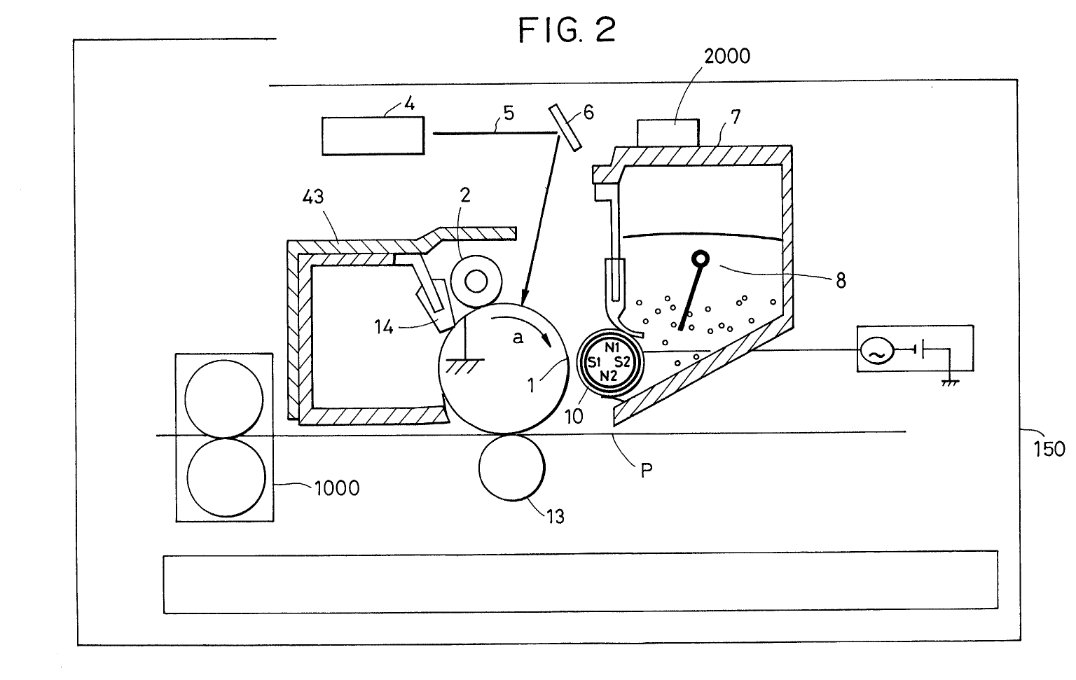

FIG. 2 is a schematic sectional view of the image forming apparatus in the first embodiment of the present invention. In particular, apparatus components relating to the image forming function are described below.

A process cartridge 43, a transfer roller 13, and an optical system, such as a laser scanner 4 and a mirror 6, are disposed in the image forming apparatus 150. The process cartridge 43 comprises various image forming process parts, such as a photoconductor 1, a charging roller 2, a developing device 7 and a cleaning device 14, which are assembled therein.

The image forming apparatus 150 includes the photoconductor 1 serving as a charged member (image bearing member). The photoconductor 1 is constructed by coating a photoconductive layer over the surface of an aluminum-made conductive base body, and is driven to rotate in the direction of arrow a in FIG. 2.

During the rotation of the photoconductor 1, it is uniformly charged with negative polarity by the charging roller 2. Then, a laser scanner 4 outputs a laser beam 5 corresponding to a time-serial electric digital image signal of image information transmitted from a video controller (not shown), whereupon an electrostatic latent image is formed on the surface of the photoconductor 1 through a mirror 6 disposed in a body of the image forming apparatus.

The electrostatic latent image on the surface of the photoconductor 1 is developed into a visible image by a toner 8 carried with the surface of a developing sleeve 10 in the developing device 7.

The visible toner image is transferred onto a sheet P by the operation of the transfer roller 13. The sheet P, onto which the visible toner image has been transferred, is separated from the photoconductor 1 and introduced to a fusing device 1000. After the toner image has been fused in the fusing device 1000, the sheet P is ejected out of the body of the image forming apparatus.

The toner 8 unused in the transfer process and remaining on the photoconductor 1 after the transfer of the toner image is removed by the cleaning device 14 and used again in a next image forming process.

The process cartridge 43 is provided with a tag 2000 including a memory (storage means) which stores identifying information, such as the serial number of the cartridge itself and the production lot numbers of the photoconductor 1, the charging roller 2, the developing sleeve 10, the toner 8, etc. When the process cartridge 43 includes no memory (storage means), an input means may be provided which enables the above-described identifying information, such as the production lot numbers, to be entered from a control panel provided on the body of the image forming apparatus. Thus, the present invention is applicable to process cartridges in various forms.

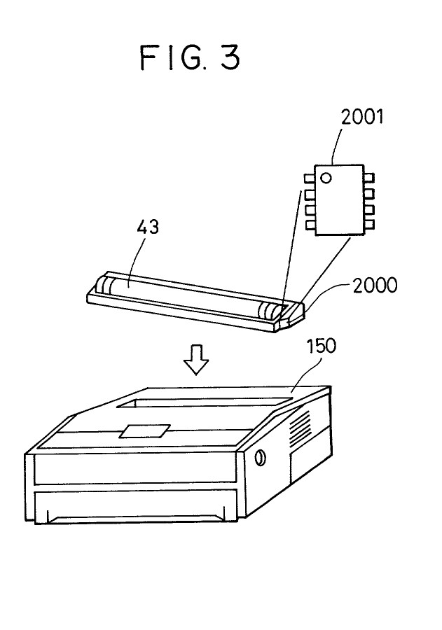

FIG. 3 shows a construction of the process cartridge 43.

As shown in FIG. 3, the process cartridge 43 is detachably loaded in the image forming apparatus 150. The tag 2000 including a memory 2001 is attached to the process cartridge 43. Upon loading of the process cartridge 43, the cartridge is electrically connected to the body of the image forming apparatus so that data can be read and written.

The memory 2001 stores, for example, identifying information such as the cartridge type ID/serial number and the production lot numbers, and operating information representing the operating status such as the number of prints and the remaining amount of toner.

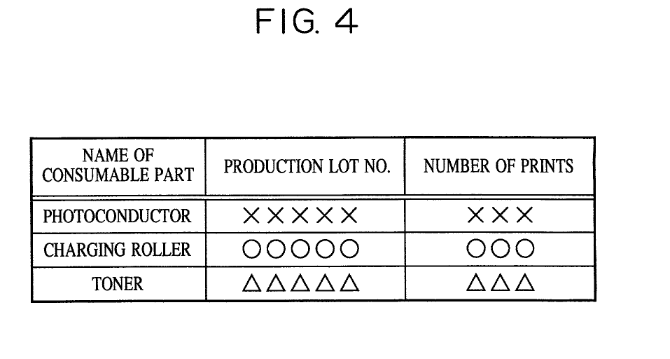

Those items of information may be stored for each of consumable parts provided in the process cartridge 43 as shown in a table of FIG. 4, or may be stored as one set of information for the whole of the process cartridge 43.

Though not shown in FIG. 3, the tag 2000 may be provided with a display panel as a display means for displaying the identifying information and the operating information.

Because the identifying information, such as ID numbers specifying the cartridge type ID/serial number and the production lot numbers, is decided during a period of manufacturing and is not changed after that, the identifying information may be recorded on a housing of the process cartridge 43 by, e.g., printing. Because the operating information, such as the total number of prints and the remaining amount of toner, is represented by values variable depending on the use of the process cartridge 43. A display panel is preferably provided to display those values.

The display panel is, e.g., a small-size liquid crystal display panel including a control circuit and a backup power supply for the panel. Alternatively, it is possible to utilize a display device in which a display state remains kept even after cutoff of a power source, such as a ferroelectric liquid crystal. In such a case, the display panel is just required to be attached to the cartridge, while the power source is supplied from the apparatus body to the cartridge. When the process cartridge has the display panel, the display is updated, for example, in match with the timing at which the remaining amount of toner is transmitted, or routinely, depending on a device utilizing the process cartridge.

Thus, a process cartridge not yet used and a process cartridge already used can be discriminated apparently by designing the cartridge so as to display by itself the identifying information such as the cartridge type ID/serial number, and the operating information indicating the operating status such as the number of prints and the remaining amount of toner.

As a result, for example, when replacing the process cartridge, an operator (user or serviceman) can be kept from falsely recognizing the spent cartridge as a new cartridge and loading the spent cartridge again.

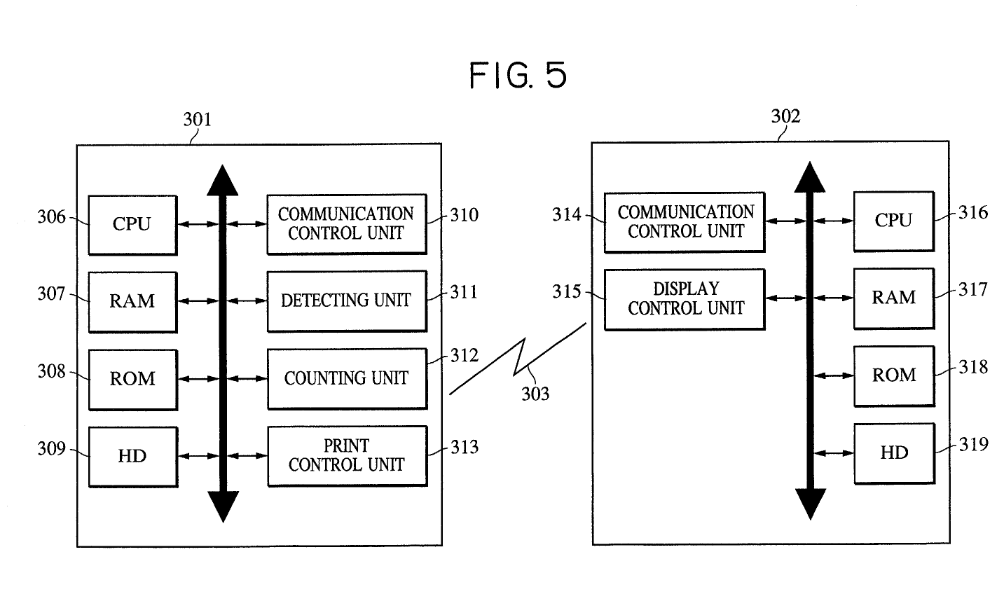

FIG. 5 is a block diagram for explaining a configuration of a system comprising an image forming apparatus and a general computer. The image forming apparatus is first described below with reference to FIG. 5.

An image forming apparatus 301 comprises a CPU 306, a RAM 307, a ROM 308, a HD 309, a system bus 304, a communication control unit 310, a detecting unit 311, a counting unit 312, and a print control unit 313.

The CPU 306 controls various functional blocks, which are connected to the system bus 304, in a supervising manner in accordance with various control software stored in the ROM 308 and other control software stored in an external memory (not shown).

The HD 309 accumulates various print data and so on. The ROM 308 stores various control software, as mentioned above, including control software for executing processing (described later) executed in the image forming apparatus. Of course, the control software may be stored in the HD 309 as a modified embodiment. The RAM 307 functions as, e.g., a main memory and a work memory for the CPU 306.

The communication control unit 310 enables the image forming apparatus 301 to be communicated with external equipment or another component unit via the Internet 303. In this embodiment, the CPU 306 and the communication control unit 310 cooperate in accordance with programs stored in the ROM 308 or the HD 309 to serve as a transmitting means for transmitting consumable-unit information of the process cartridge 43, etc., to the image forming apparatus manager 200 (distribution server) and as a software receiving means for receiving control software from the image forming apparatus manager 200.

The detecting unit 311 has the function of detecting various kinds of signals, such as various error information in the image forming apparatus, operating information of a printer, and identifying information read from the image forming apparatus.

The counting unit 312 has the function of counting various values of operating information, such as the number of prints output from the printer and the number of times of jams in the image forming apparatus sensed by the detecting unit 311.

In this embodiment, the detecting unit 311 and the counting unit 312 constitute an operating status management means for managing the operating status of a consumable unit. The operating information detected by the detecting unit 311 and totalized by the counting unit 312 is stored in the HD 309 or the memory 2001 (storage means) of the tag 2000 provided on the process cartridge 43 (FIG. 3).

Though not shown, the image forming apparatus 301 also includes a display control unit, which has the function of controlling a display performed on a display unit of the image forming apparatus.

The print control unit 313 is a control means having the function of controlling formation of an image printed on a recording medium output from the image forming apparatus.

Numeral 302 in FIG. 5 denotes a computer body. The computer configuration shown in FIG. 5 represents a typical one of, e.g., the host computer 300 and the image forming apparatus manager 200, shown in FIG. 1, and various servers connected to the Internet.

The computer 302 comprises a CPU 316, a RAM 317, a ROM 318, a HD 319, a system bus 305, a communication control unit 314, and a display control unit 315. Respective blocks similar to those in the image forming apparatus 301 have the same functions as described above, and hence a description thereof is not repeated here. However, the HD 319 stores various information, such as control software (described later) for controlling the image forming apparatus, and functions as a database.

The processing operation of this embodiment is described below based on the above-described construction (block functions).

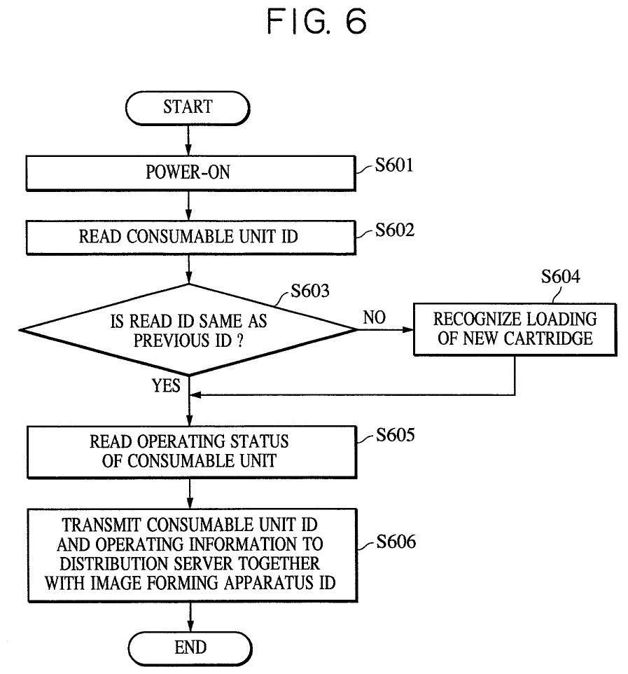

FIG. 6 is a flowchart showing processing executed in the image forming apparatus described above. The processing of each step is realized by the CPU, provided in the apparatus body, reading and executing control programs, which are stored in a nonvolatile storage means, such as the ROM or HD, and execute the processing shown in FIG. 6.

First, the CPU 306 checks in step S601 whether a main power source of the image forming apparatus is turned on. For easier understanding, it is assumed in this flowchart that the CPU proceeds to a next step upon recognizing turning-on of the main source.

In step S602, the CPU reads the ID number of a consumable unit loaded in the image forming apparatus. The ID number is stored in a memory associated with the consumable unit. The term “ID number” used herein means identifying information for identifying the consumable unit, and may include, e.g., the model of the consumable unit, the production serial number in a factory, and the production lot number. The ID number of the consumable unit can also be utilized as information corresponding to combinations of the production lot numbers of parts making up the consumable unit, but this point will be described later in more detail.

In step S603, it is checked whether the ID number read and input to a processing unit is the same as that previously read. The previous ID number is stored and held in a rewritable storage unit, e.g., the HD 309, provided in the image forming apparatus. Specifically, the CPU 306 compares the read ID number with the ID number held in the storage unit, e.g., the HD 309, thereby determining whether the read ID number is the same as the previous one.

If it is determined in step S603 that the read ID number differs from the previous one, this is recognized in step S604 as meaning loading of a new cartridge. In this case, predetermined processing required upon replacement of a cartridge, such as update of information regarding the cartridge which is stored in the HD 309, is also executed simultaneously with step S604.

In step S605, the operating status, i.e., the operating information, is read from the counting unit 312 shown in FIG. 5. The operating information may be read from the memory associated with the cartridge, or from the HD 309 provided in the apparatus body. By thus acquiring the operating information of a new consumable unit in step S605, the operating status of the new consumable unit can be notified to the image forming apparatus manager 200.

If it is determined in step S603 that the read ID number is the same as the previous one, the operating information of the existing consumable unit is read from the counting unit 312.

In step S606, the CPU transmits, to the image forming apparatus manager 200 (distribution server), consumable-unit information including the ID number (identifying information) and the operating information, which have been read in steps S602 and S605, together with the ID number of the image forming apparatus itself, in which the consumable unit is loaded, whereby the processing of FIG. 6 is completed.

In the above description of FIG. 6, the ID number and the operating information of the consumable unit, and the ID number of the image forming apparatus are notified to the image forming apparatus manager 200 in the flowchart that is started upon turning-on of the main power source in step S601. However, the flowchart of FIG. 6 may be modified such that the processing of steps S602 to S606 in FIG. 6 is executed at the predetermined interval timing.

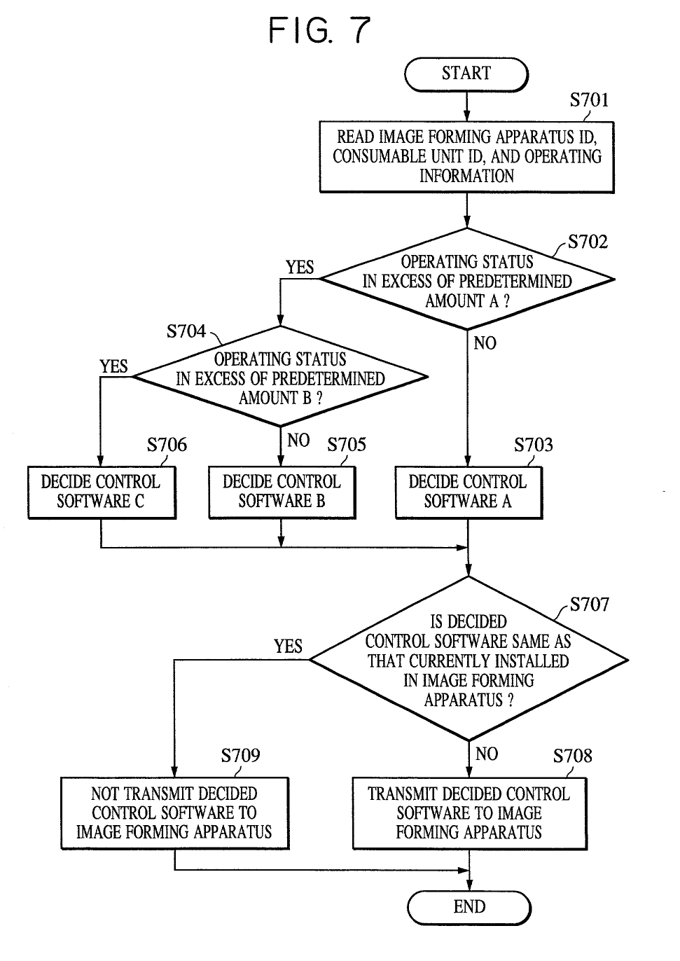

The processing executed on the distribution server side upon receiving the consumable-unit information transmitted from the image forming apparatus side is described below with reference to FIG. 7. The processing of each step in FIG. 7 is realized by the CPU 316, provided in the distribution server, reading and executing control programs, which are stored in the ROM or HD to execute the processing shown in FIG. 7.

In step S701, the CPU reads the ID number of the image forming apparatus, the ID number of the consumable unit, and operating information indicating the operating status of the consumable unit, which have been received from the image forming apparatus side. The feature of the present invention resides in this point. Stated otherwise, the production lot number of the consumable unit can be recognized from the ID number of the consumable unit received in step S701, and the distribution server is able to decide, as image formation control software to be distribution to the user side, software or a control value (control parameter related to the image forming operation) corresponding to the ID number.

In step S702, the CPU determines whether the read operating information (status) exceeds a predetermined amount A. A value of the predetermined amount A is decided depending on the ID number of the image forming apparatus or the ID number of the consumable unit which has been read in step S701. For example, the predetermined amount A has a different value if the ID number of the consumable unit differs. More specifically, software or control values depending on the operating information per ID number of the consumable unit are held as a part of a database in the distribution server. When the ID number corresponds to, e.g., the production lot number, it is possible to decide the optimum software or control value depending on the production lot number and the operating information, and to distribution the decided image formation control software to the user side.

If it is determined in step S702 that the predetermined amount A is not exceeded, control software A is decided as distribution candidate software (step S703).

On the other hand, if it is determined in step S702 that the predetermined amount A is exceeded, the CPU further determines in step S704 whether the read operating information (status) exceeds a predetermined amount B.

If it is determined in step S704 that the predetermined amount B is not exceeded, control software B is decided as distribution candidate software (step S705). If it is determined in step S704 that the predetermined amount B is exceeded, control software C is decided as distribution candidate software corresponding to a predetermined amount C (step S706).

Then, software currently installed in the image forming apparatus is specified based on the ID number of the image forming apparatus, and the type of the specified software is compared in step S707 with the type of the software decided as described candidate software. Herein, corresponding to the ID number of the image forming apparatus, the type of the image forming apparatus, the apparatus owner, the starting date of use of the apparatus, the network address as the destination of distribution, the currently installed software, etc., are managed as a part of a database in the host computer 300.

If it is determined in step S707 that the specified software is the same as the currently installed software, the image formation control software is not distributed (step S709). If it is determined that the specified software is not the same as the currently installed software, the image formation control software having been decided as distribution candidate software is distributed in step S708. As a more preferable embodiment, the image formation control software decided through steps S703, S705 and S706 may be distributed without executing the processing of step S707 on the distribution server side, and the image forming apparatus having received the image formation control software distributed from the distribution server side may execute the processing corresponding to step S707 by determining whether the received image formation control software is the same as the currently installed software. That embodiment is effective in dispersing the load imposed on the distribution server.

Thus, since the distribution server side or the image forming apparatus side executes the processing to efficiently determine the necessity of updating the image formation control software, it is possible to keep users free from troublesome work to the utmost, for example, even when there are many kinds of software. Further, on the distribution server side, a distribution server is able to realize unified management of a plurality of image forming apparatuses regarding actual conditions, such as how long and how respective process cartridges have been used. The information used in the unified management can also be utilized to carry out, for example, production estimation and inventory management of cartridges.

Additionally, it is assumed that the predetermined amounts A, B and C are selected to satisfy the relationship of the predetermined A<the predetermined B<the predetermined amount C. Also, while the operating status of the image forming apparatus or the consumable unit has been evaluated in three stages in the flowchart of FIG. 7, the present invention is not limited to the evaluation in three stages. It is an essential feature of the present invention that a predetermined determination process is performed depending on the operating status of the consumable unit to decide the optimum image formation control software.

Further, the image formation control software as a distribution candidate is decided depending on not only the operating status of the consumable unit, but also the ID number of the consumable unit.

The term “image formation control software” used herein is not limited to a control program for controlling the image forming apparatus, and includes data such as a setting value or a parameter used in the control program.

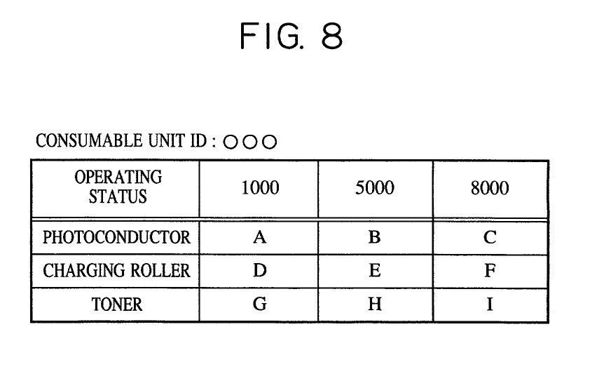

Various pieces of image formation control software (or control values) are managed as a part of the database prepared in the HD 319 of FIG. 5 in correlation to the identifying information, the operating information of the consumable unit, etc. FIG. 8 schematically shows one example of data corresponding to one predetermined ID number managed in the database. In FIG. 8, alphabets A to I represent individual pieces of image formation control software. In practice, such data as shown in FIG. 8 is stored in the distribution server in the form searchable per ID number (e.g., per production lot number).

By managing the database based on the information as shown in FIG. 8, the system is adaptable for the situation that characteristics of consumable units are changed per production lot, or that characteristics of consumable units are changed depending on the operating status even when the consumable units belong to the same production lot, or that characteristics of consumable units are changed depending on consumable parts making up each consumable unit.

In other words, the image formation control software to be distributed to the image forming apparatus is managed as a part of the database in the host computer 300 corresponding to combinations of the production lot, the operating status, and the consumable parts described above. Therefore, the image formation control software capable of forming a high-quality image can be provided to the image forming apparatus.

A summary of the construction and processing of this embodiment has been described above. A more detailed description will be made below in connection with, as one example of consumable units, a process cartridge loaded in a laser beam printer or the like.

It is apparent that the present invention is not limited to a laser beam printer and a process cartridge, but also applicable to other types of image forming apparatuses, e.g., copying machines, composite machines, scanners and facsimiles, as well as to other types of consumable units, e.g., ink cartridges and paper cartridges.

(Difference in Photoconductor Characteristics Depending on Production Lot)

A description is now made of how an image is affected depending on the production lot of a photoconductor that is one of consumable parts making up a process cartridge. A difference in the production lot means that when the same type of consumable parts are manufactured for a long term, it is difficult to manufacture products having identical characteristics under exactly the same conditions in points of materials, environment, etc., and variations in specific properties of materials, changes in production environment, etc., are unavoidable. The effect of a difference in the production lot caused by those reasons upon characteristics of a photoconductor is described by way of example.

Depending on the lot of an organic photoconductor, a variation in the range of about 30 V occurs in a light area potential (represented by V1 hereinafter) even under a condition of the same light amount. Such a 30 V-variation with respect to the light amount appears as a difference of about 20 μm in a line width when a latent image is developed.

Thus, even in the same image forming apparatus, when a process cartridge having a different production lot is loaded in it, a significant difference appears in density and line thickness of a formed image.

One photoconductor having sensitivity at the design center, for example, requires the light amount of 0.32 μJ/cm² to obtain V1 of −150 V relative to a dark area potential of −670 V.

Practically, however, photoconductors may be often manufactured at two different lots A and B having upper and lower limits in sensitivity variations. In such a case, the upper and lower limits correspond to V1 of −165 V and −135 V, respectively, for the same light amount of 0.32 μJ/cm². Those sensitivity variations are attributable to variations in the dispersed state and thickness of pigment in a charge generating layer and in the thickness of a charge transport layer, these layers forming the photoconductor.

When conditions for development and so on are set in match with V1 of −150 V, the light amount of 0.34 μJ/cm² and 0.31 μJ/cm² are required for the photoconductors of the lot A and the lot B, respectively, so that the same line width is maintained in design. In other words, it is usual that the relationship between the light amount and the potential is not linear for individual photoconductors. Further, when photoconductors are operated in practical use over time, there usually occurs a sensitivity shift. Such a sensitivity shift also varies depending on the lot.

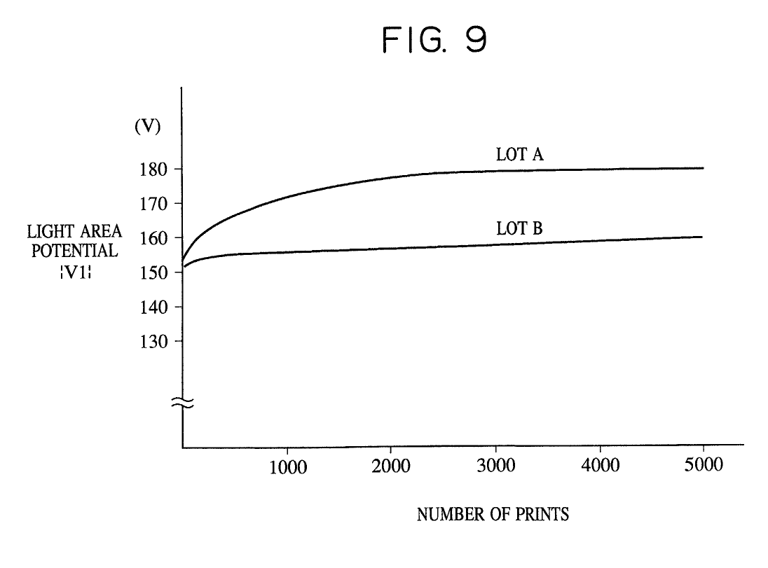

FIG. 9 shows one example of the sensitivity shift. In the example of FIG. 9, even when the light amount is initially adjusted to provide V1 of −150 V for the photoconductor of one lot A, the light area potential shifts to −170 V at the time the number of prints reaches 1000 sheets, and to finally −180 V at the time the number of prints reaches 5000 sheets.

In such a case, to maintain the density and the line width at proper values, the photoconductor must be controlled so as to increase the light amount to 0.35 μJ/cm² at 1000 sheets of prints and to 0.36 μJ/cm² at 5000 sheets of prints.

For the photoconductor of the other lot B in which the light amount is likewise initially adjusted to provide V1 of −150 V, the light area potential slightly shifts to −155 V at 1000 sheets of prints and is held at −160 V even at 5000 sheets of prints. In this case, control to change the light amount is not necessarily required at 1000 sheets of prints, and the light amount is just required to increase to 0.32 μJ/cm² at 5000 sheets of prints.

Thus, by installing control software, which is able to execute a process for compensating the light amount as described above, in the image forming apparatus, it is possible to always obtain the desired light amount and provide recording mediums printed with good quality to users. As one example of the image formation control software in this embodiment, software or a control parameter for operating the computer to execute control for changing the light amount in such a manner is distributed to the image forming apparatus from the distribution server.

A description is now made of an example in which, depending on photoconductors of different lots, the image formation control software is automatically installed in match with the setting based on a lot difference according to this embodiment.

The following is an example of results obtained by comparing sensitivities of two cartridges having different lot numbers only in photoconductors, but having the same lot numbers in all other parts (consumable parts).

When the process cartridge 43 is loaded in the image forming apparatus 150, the lot of a photoconductor, i.e., the lot A or B in this embodiment, is read and then transmitted to the image forming apparatus manager 200. Upon determining the lot number of the photoconductor, the image forming apparatus manager 200 distributes light-amount setting software for the photoconductor of the lot A or for the photoconductor of the lot B to the image forming apparatus 150. In the image forming apparatus 150, the received light-amount setting software is automatically installed and light amount control is executed in a proper manner.

Table 1 given below shows results of comparing a line width of 4 dots at 600 dpi obtained by each of the process cartridges of the lots A and B according to this embodiment under default setting, and similar line widths obtained by the process cartridges of the lots A and B when respective pieces of light-amount setting software for the photoconductor of the lots A and B are installed.

TABLE 1

| | Photoconductor | Photoconductor |
|---|---|---|
| | of lot A | of lot B |
| Default light amount | 175 μm | 185 μm |
| Light amount for lot A | 178 μm | — |
| Light amount for lot B | — | 180 μm |

As seen from the results shown in Table 1, the line width obtained by the photoconductor of the lot A was 10 μm smaller than that obtained by the photoconductor of the lot B. However, the difference between the line widths obtained by the photoconductors of the lots A and B was reduced to 2 μm when the light amount was set to a desired value for the photoconductor of each lot.

In other words, although the photoconductors of the lots A and B have a slight difference in sensitivity between them, the difference is compensated by automatically distributing and installing the light-amount setting software, which varies the light amount to a desired value for each lot, to and in the image forming apparatus of a relevant user, whereby the above results are achieved.

(Difference in Charging Roller Characteristics Depending on Production Lot)

A description is now made of how an image is affected depending on the production lot of a charging roller that is one of consumable parts making up a process cartridge.

A charging roller is generally constructed such that a low-resistance sponge made of, e.g., EPDM (ethylene-propylene-diene-monomer) is coated on a core metal, and a high-resistance surface layer made of, e.g., urethane is coated on the sponge. To prevent a variation in charging, a DC voltage superimposed with an AC voltage is applied to the charging roller.

As is apparent from the structure of the charging roller, however, a resistance value of the charging roller differs depending on the lot number (i.e., manufacturing conditions) due to variations in the mixed state of carbon in the EPDM, the foamed state of the sponge, and the thickness of the surface urethane layer.

Furthermore, because makers employ different conditions in the process of manufacturing charging rollers, there are proper values of the AC voltages to be applied to individual charging roller manufactured by different roller makers. The reason is that, if a higher value of Vpp (see Table 2) is set for a charging roller of a lot providing a relatively low resistance, a pinhole may be formed at a peak value of the applied voltage in an area where the resistance of a photoconductor is relatively low.

On the other hand, if a lower value of Vpp is set for a charging roller of a lot providing a relatively high resistance, a black dot may occur on an image because the charging history generated on a photoconductor cannot be completely canceled through a transfer.

Thus, since charging rollers have specific I−V characteristics depending on respective manufacturing conditions as shown in FIG. 9, they should be used in proper voltage ranges.

Table 2 given below shows proper voltage ranges for charging rollers manufactured by different makers at respective lots, i.e., by a company C at a lot C1, a company D at a lot D1, and a company E at a lot E1. Note that the companies C, D and E are makers manufacturing the same type of products under different manufacturing conditions (such as the place of purchase and quality of materials) and environment conditions (such as a temperature and moisture).

TABLE 2

| | Black dot | | Pin hole limit |
|---|---|---|---|
| | generation voltage | Iac | voltage |
| | Vpp (kV) | (μA) | Vpp (kV) |
| Company C and | 1.50 | 270 | 2.7 |
| lot C1 | | | |
| Company D and | 1.55 | 230 | 2.6 |
| lot D1 | | | |
| Company E and | 1.65 | 250 | 2.5 |
| lot E1 | | | |

From Table 2, it is seen that, regarding the charging rollers manufactured by those three makers, Vpp should be set to the proper range of 1.5 to 2.7 kV for the lot C1, to the proper range of 1.55 to 2.6 kV for the lot D1, and to the proper range of 1.65 to 2.5 kV for the lot E1.

In such voltage control, as with the above-described light amount control for photoconductors, variations in the desired voltage value among charging rollers of different lots can be properly compensated by receiving, from the image forming apparatus manager 200, optimum control software or control value distributed from the distribution server based on the production lot information of the relevant charging roller, the ID number of a corresponding consumable unit, etc., which are stored in the memory 2001 of the process cartridge 43, and then operating the image forming apparatus so as to perform the voltage control in accordance with the distributed control software or control value.

(Difference in Toner Characteristics Depending on Production Lot)

A description is now made of a toner that is one of consumable parts making up a process cartridge. As for a toner, setting is varied depending on a difference in the toner particle size.

More specifically, the toner is measured for the mean particle size by weight using Coulter Counter TA-II or Coulter Multi-sizer (made by Coulter Co.). An aqueous solution of 1% NaCl is prepared as an electrolyte using first-grade sodium chloride. For example, ISOTONER-II (made by Coulter Scientific Japan Co.) is usable. The measurement is performed by adding 0.1 to 5 ml of a surfactant (preferably alkylbenzene sulfonate), as a dispersant, in 100 to 150 ml of the electrolytic aqueous solution, and further adding 2 to 20 mg of a sample to be measured. Thereafter, the electrolyte including the sample suspended therein is dispersed for about 1 to 3 minutes using an ultrasonic disperser. A volume distribution and a number-of-particles distribution are calculated by measuring the volume and the number of toner particles having the size of not less than 2 μm with the above-mentioned measuring device while employing a 100-μm aperture.

For example, when the toner has the mean particle size by weight of, e.g., 6.5 μm in design, upper and lower particle size limits are respectively 7.0 μm for a lot F and 6.0 μm for a lot G. In that case, the toner of the lot F having the particle size at the upper limit has a smaller surface area per unit volume, and exhibits a relatively low level of tribo-electricity. This means that the density of an image tends to reduce. Therefore, the development contrast is increased correspondingly so as to maintain a desired density.

More specifically, assuming that the development contrast |Vdc-V1|, which is defined as an absolute value between V1 and a development sleeve potential Vdc, is set to 300 V for the toner having the particle size at the design center, the development contrast is set to 330 V for the toner having the particle size at the upper limit. On the other hand, the toner having a smaller particle size exhibits a relatively high level of tribo-electricity and tends to cause a stronger development force correspondingly. Therefore, the development contrast is reduced to 270 V so as to prevent an excessive increase of the density.

The reason why a toner has different particle sizes is that, when the toner is produced by pulverization, produced toner particles having different sizes are screened using a sieve and only toner particles within a certain range of size are selected for use. Further, since the toner itself is a mixture of a resin, a magnetic substance, a pigment, a charge control agent, etc., it is practically difficult to obtain a toner having a uniform particle size.

Recently, some of toners is produced by a polymerization process other than pulverization. Even with the polymerization process, since the reaction rate in a solution cannot be controlled to become uniform everywhere, it is unavoidable that the toner particle size has a certain degree of variations.

One practical example is described below. Table 3 given below shows results of preparing three kinds of setting, i.e., default development bias setting at which Vdc-V1 (V1=−150 V) is 300 V, development bias setting for a toner of a lot F at which Vdc-V1 is 330 V, and development bias setting for a toner of a lot G at which Vdc-V1 is 270 V, and then comparing reflection densities of a black solid image obtained by combinations of the toner lots and the development bias settings corresponding to the toner lots. The reflection density was measured using a reflection densitometer made by Macbeth Co.

TABLE 3

| | Lot F | Toner of | Lot G |
|---|---|---|---|
| Development bias | (particle | particle size | (particle |
| setting/toner | size 7 μm) | 6.5 μm | size 6 μm) |
| Default | 1.25 | 1.40 | 1.53 |
| development bias | | | |
| setting (−450 V) | | | |
| Development bias | 1.40 | — | — |
| setting for lot | | | |
| F (−480 V) | | | |
| Development bias | — | — | 1.41 |
| setting for lot | | | |
| G (−420 V) | | | |

As seen from the results shown in Table 3, the reflection density under the default development bias setting was reduced to a slightly thin level of 1.25 for the toner of the lot F, and was increased to a slightly dense level of 1.53 for the toner of the lot G. By developing the toner under the development bias setting in match with the toner lot, the reflection density became approximately 1.4 for the toner of each lot. Thus, variations in the reflection density between the toners of different lots could be suppressed.

In such development bias control, as with the above-described light amount control for photoconductors, variations in the bias voltage value among toners of different lots can be properly compensated by receiving, from the image forming apparatus manager 200, optimum control software or control value distributed from the distribution server based on the production lot information of the relevant toner, the ID number of a corresponding consumable unit, etc., which are stored in the memory 2001 of the process cartridge 43, and then operating the image forming apparatus so as to perform the voltage control in accordance with the distributed control software or control value.

(Decision of Control Software Depending on Combination of Production Lots of Consumable Parts)

While three consumable parts of a cartridge, i.e., three factors affecting an image formed using a cartridge, have been described above, the optimum control software or control values are finally decided in consideration of combinations of those three factors. Assuming, for example, that the production lot is divided into three conditions for photoconductors, three conditions for charging rollers, and two conditions for toners as described above, the number of combinations is given by 12=2×3×2. Note that, for the convenience of explanation, each consumable part of each cartridge is in the same operating status.

Control software or control values to be decided corresponding to the respective combinations are stored and managed as a part of the database in the host computer 300 of the distribution server. Then, the host computer 300 instructs the image forming apparatus manager 200 to execute a distribution process with respect to the outside via the predetermined communication line for setting the optimum control software or control value in the image forming apparatus depending on each combination of the lot numbers of the consumable parts.

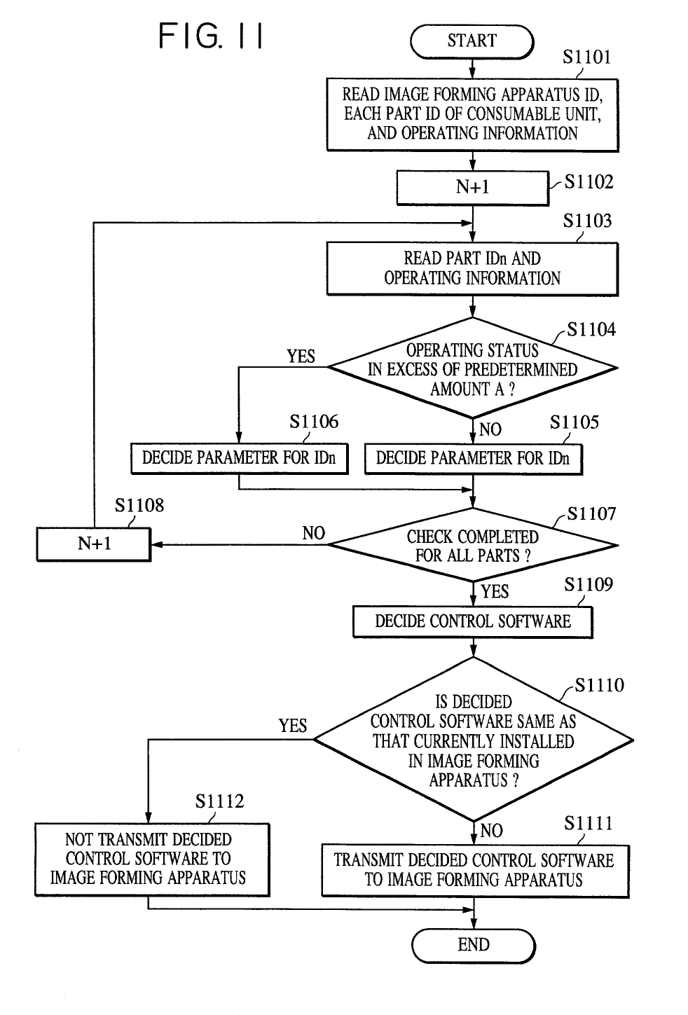

FIG. 11 is a flowchart showing processing executed to decide distribution control software in the distribution server. The decision processing is described below with reference to the flowchart of FIG. 11 in more detail than the above description made with reference to the flowchart of FIG. 7. Note that the flowchart of FIG. 11 is similarly applied to the case of deciding the optimum control values. Also, the processing of each step in FIG. 11 is realized by the CPU, provided in the distribution server, reading and executing control programs, which are stored in the ROM or HD.

First, in step S1101, the CPU reads identifying information, such as the ID number of the image forming apparatus and the ID number (production lot number) for each part of the consumable unit, and operating information for each part of the consumable unit, which have been received from the image forming apparatus side. The feature of the present invention resides in this point.

Based on the ID number of the image forming apparatus, the distribution server is able to confirm information such as regarding where the image forming apparatus is installed, what type it is, and who is the owner. Stated otherwise, ID data of the image forming apparatus is stored and managed as a part of the database in the distribution server beforehand in correlation to the above items of information. Those items of information can be, for example, registered in the distribution server from the user side via the Internet. The reading of the identifying information and the operating information for each consumable part is realized by transmitting the information to the image forming apparatus manager 200 from the side of the image forming apparatus in step S606 of FIG. 6 described above.

Then, in step S1102, an initial value 1 is set to a variable n.

In step S1103, the CPU reads the ID number and the operating information for each part corresponding to the variable n. In step S1104, the CPU determines whether the read operating status corresponding to the variable n exceeds a predetermined amount A. In accordance with the determination on the predetermined amount A, a parameter for deciding the control software to be finally distributed is decided (in step S1105 or S1106).

In step S1107, the CPU determines whether the operating information has been completely checked for all the parts and the parameter for deciding the distributed control software has been decided for all the parts. If not yet completed, the variable n is incremented by one in step S1108, and the processing to decide the control parameter for deciding the distributed control software is repeated for another part.

Herein, the parameter decided for each part corresponds to A, C, F and so on in Table 4 given below. The control software to be distributed from the distribution server to the image forming apparatus is decided depending on the combination of respective parameters (step S1109).

TABLE 4

| | Photo- | Charging | |
|---|---|---|---|
| Cartridge | conductor | roller | Toner |
| 1 | A | C | F |
| 2 | A | C | G |
| 3 | A | D | F |
| 4 | A | D | G |
| 5 | A | E | F |
| 6 | A | E | G |
| 7 | B | C | F |
| 8 | B | C | G |
| 9 | B | D | F |
| 10 | B | D | G |
| 11 | B | E | F |
| 12 | B | E | G |

The decision of the distributed control software in step S1109 is made by referring to the database where various pieces of control software are stored corresponding to the combinations of the parameters decided depending on the ID number and the operating information for each part, which are stored and held as a part of the database in the distribution server.

In step S1110, the distribution candidate control software decided in step S1109 is compared with the control software currently installed in the image forming apparatus, which has been read in step S1101.

The comparison is performed on condition that various kinds of information regarding the image forming apparatus are stored and managed corresponding to the identifying information on the distribution server side. The flowchart of FIG. 11 is realized by storing and managing at least the control software, which is currently stored in the image forming apparatus, as a part of the database on the distribution server side corresponding to the ID number of the image forming apparatus.

If the control software currently installed in the image forming apparatus is the same as the distribution candidate control software decided in step S1109, no control software is distributed (step S1112). If it is determined that the currently installed software is not the same as the decided one, the decided control software is distributed (step S1111).

With the flowchart of FIG. 11, control setting can be made in a finer manner depending on the combination of the part lots (or the serial number) and the usage status (operating information). Fine properties (such as a density and a line width) of an image, which have been difficult to control properly, can be reproduced with higher fidelity.

Control software generally used in offices and so on for image processing at present is of the type adaptable for any operating status possibly occurred in the image forming apparatus, and hence it has a disadvantage in requiring a large capacity in space of a memory. Further, such control software is designed so as to execute multi-functions while fine control properties are sacrificed to some extent. In contrast, the flowchart of FIG. 11 can provide advantages in that the control software adaptable for the operating status of the image forming apparatus in a finer manner can be realized with a program having the least necessary capacity, and the load imposed on the distribution server when transmitting the decided control software can be held as small as possible. Further, since the control program is divided into smaller sections corresponding to individual control targets, finer control of the image forming apparatus can be realized.

With this embodiment, as described above, optimum image formation control software can be downloaded based on the identifying information, the operating information and so on of a consumable unit, which are stored in a memory associated with a cartridge.

The reasons why the optimum image formation control software is downloaded in the body of the image forming apparatus when it is used, instead of storing it in the cartridge memory during the manufacturing process of the cartridge, reside in saving the capacity of the cartridge memory and cutting down the cost, enabling the optimum image formation control software to be updated depending on the operating status of the cartridge, and enabling a plurality of above-mentioned control factors on the cartridge side to be controlled to proper values adaptively in combination with a body residing program stored in the HD or another memory on the image forming apparatus side.

Further, a longer manufacturing time would be required if data is written in each cartridge memory on the manufacturing side, and hence subsequent downloading of data into the cartridge memory is more advantageous from the cost-effective point of view as well.

(Second Embodiment)

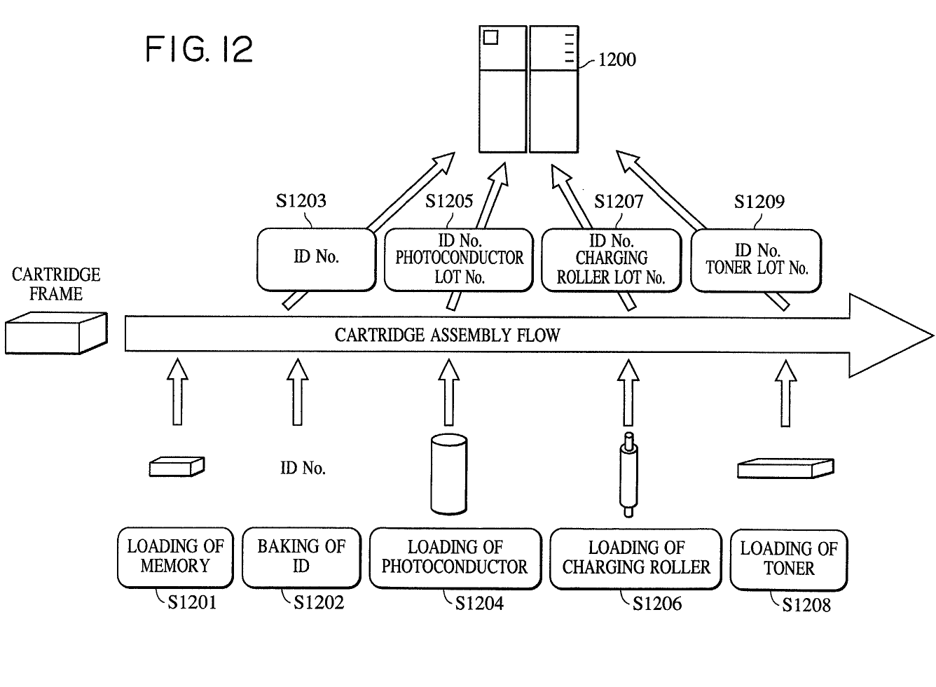

A second embodiment of the present invention will be described with reference to FIGS. 12 to 14.

In this embodiment, a description is made of one example of a manner for setting in a practical manufacturing process the ID number, etc., described above in the first embodiment. The following description is premised on that the ID number of a cartridge, identifying information for each consumable part, etc., are set in the manufacturing process of the cartridge and are utilized for distribution of image formation control software.

There are problems, given below, with variations in characteristics of consumable parts depending on the production lot in addition to those ones described above in connection with the first embodiment.

A development blade as one of consumable parts making up a process cartridge is often subjected to variations in its thickness depending on the production lot. If a development blade has a larger thickness, the force pressing a toner against a development sleeve is increased and charges are imparted to it with higher efficiency, thus resulting in a higher density.

It is, for example, assumed that a standard thickness of the development blade is 1.5 mm and an allowance of the blade thickness is ±0.1 mm. Since the pressing pressure varies in proportion to the third power of the thickness, the pressing pressure is changed to 121% and 81% at upper and lower limits, respectively, with a central value being 100%. Such a difference reflects on a density difference in the range of approximately 0.1.

Further, the surface roughness of a development sleeve, which is another consumable part of a process cartridge, often differs from one to another depending on a difference in a sleeve coating. This also causes a lot variation because different degrees of the surface roughness form a toner on the development sleeve in different values of thickness and hence varies the density of a formed image. Assuming that 10-point means surface roughness Rz of a standard sleeve coating is 1.6 mm, the actual surface roughness varies from 1.7 mm at an upper limit to 1.5 mm at a lower limit. Correspondingly, the density varies over the range of +0.05 to −0.05 relative to a standard value.

Thus, even only a developing means includes various factors changing the image quality. Considering factors of a photoconductor, a charging roller, a toner and others parts described above in connection with the first embodiment, it is difficult to incorporate, in a cartridge memory, all of necessary control information during the assembly steps of a process cartridge. In particular, time-dependent changes in characteristics of a photoconductor can be determined after evaluating the completed photoconductor over a certain period of time, and it is difficult to write the necessary control information in the cartridge memory when the cartridge is delivered.

In this embodiment, therefore, the ID number (identifying information) of each consumable part is stored in a memory as a storage means associated with a process cartridge and the identifying information is registered in a host computer during assembly steps of the process cartridge so that optimum image formation control software can be installed in the image forming apparatus depending on the combination of the consumable parts when the cartridge is not assembled, but used.

More specifically, as shown in FIG. 12, in assembly steps of a cartridge, the ID number (identifying information) of the cartridge is first stored in an associated memory. Then, corresponding to the stored ID number, the types of a photoconductor, a charging roller, a toner and others parts, which have been assembled in the cartridge, are accumulated together in a host computer 1200.

Such information may be stored in the form of cartridge numbers shown in Table 4 described above in the first embodiment. For example, information indicating that a No. 1 cartridge is a combination of a photoconductor A, a charging roller C, and a toner F, is stored and managed in a rewritable nonvolatile storage means, such as a hard disk in the host computer, along with the ID numbers.

An assembly flow of the cartridge is described in sequence with reference to FIG. 12.

First, a memory is attached to a cartridge frame (step S1201). The ID number as identifying information of the cartridge is baked on the cartridge frame (step S1202). The ID number is also registered in a nonvolatile storage means, such as a hard disk, as a part of a database in the host computer 1200 in the searchable form (step S1203).

Then, in step S1204, a photoconductor is loaded in the cartridge frame. At this time, the cartridge ID number is read out of the memory associated with the cartridge frame and is registered as a part of the database in the host computer 1200 together with the lot number of the photoconductor (step S1205). The term “lot number” used herein means the production lot number.

In step S1206, a charging roller is loaded in the cartridge frame. At this time, the cartridge ID number is similarly read out of the memory associated with the cartridge frame and is registered in the database of the host computer 1200 together with the lot number of the charging roller (step S1207).

Step S1208 is a toner filling step in which the cartridge ID number and the lot number of the toner are also similarly registered in the database of the host computer 1200 (step S1209).

In such a way, the lot numbers of necessary parts are stored in successive assembly steps together with the cartridge ID number until the cartridge is completed. Stated otherwise, the host computer 1200 (corresponding to the host computer 300 in FIG. 1) has the function of, in response to a designation of the cartridge ID number, specifying the lot number of each part corresponding to the designated ID number. For example, when the cartridge ID number is notified from an information processing apparatus or an image forming apparatus capable of communicating data via a network, the host computer 1200 is able to specify the lot number of each part corresponding to the notified ID number.

The cartridge ID number described above with reference to FIG. 12 corresponds, by way of example, to the ID number of the consumable unit transmitted from the user side.

The manner of storing the necessary information through the above-described steps is more efficient than the case of storing control data in the memory associated with the cartridge, which is one example of the consumable unit, whenever each part is assembled in the cartridge. It is also conceivable to write control data for the parts of all lots in the cartridge memory at a time after the assembly steps. However, because the operation for recording data in a memory usually takes a longer time than that for reading data out of the memory, the work efficiency in manufacturing of the cartridge is improved by accumulating the ID number and the lot data in external equipment (host computer 1200) as executed in this embodiment. Further, this embodiment is also modifiable to be adapted for the case of, as described above in the first embodiment, distributing setting values or control software depending on the combination of the consumable parts in consideration of the operating status of each consumable part as well.

While the embodiment of FIG. 12 has been described as storing the cartridge ID number in the memory associated with the cartridge, the embodiment is also modifiable to be adapted for the case, in which the cartridge is provided with no memory, by recording the cartridge ID number stored in step S1203 on the cartridge frame or a box for packing the cartridge therein. In such a case, together with the recorded cartridge ID number, the ID number of each consumable part corresponding to the cartridge ID number is also managed in the host computer 1200. With that modification, it is possible, for example, to enter the ID number of the consumable unit from a control panel of the body of the image forming apparatus on the user side, thereby requesting the host computer 1200 (distribution server) to distribute the image formation control software corresponding to the ID number of the consumable unit.

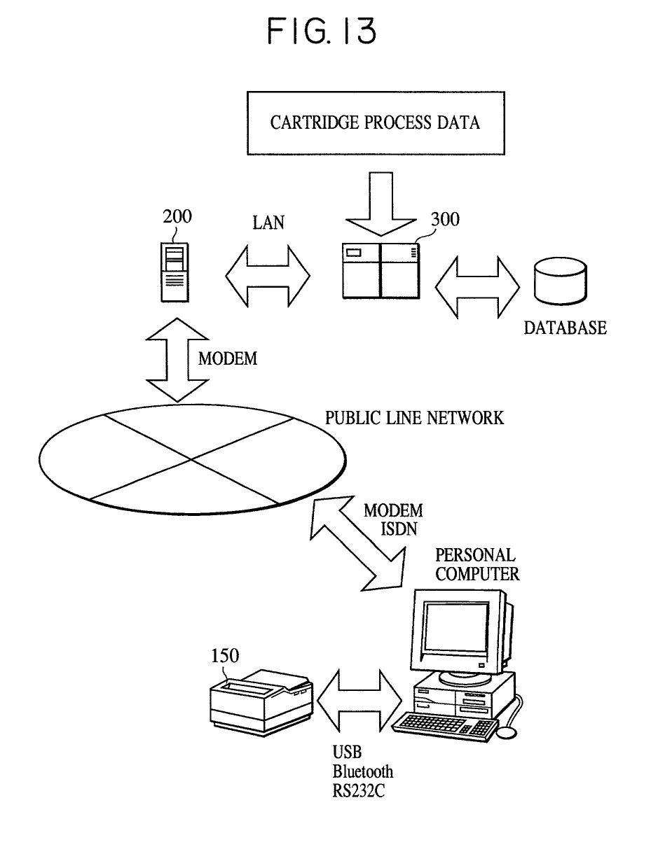

FIG. 13 is a conceptual diagram of an overall distribution system for transmitting the image formation control software to a cartridge of an image forming apparatus on the user side by utilizing data registered in the host computer 1200 during the assembly steps of the cartridge.

The data sent from the assembly process is input to a host computer 300 (corresponding to the host computer 1200 in FIG. 12) managing a database, in which image formation control software is stored, and is stored in a storage unit.

In this embodiment, when a process cartridge is loaded in the body of the image forming apparatus installed on the user side, identifying information, such as the ID number of the cartridge and the production lot numbers of consumable parts, and operating information of the consumable parts are responsively transmitted to the image forming apparatus manager 200 via a communication line, e.g., the Internet.

The image forming apparatus manager 200 acquires optimum image formation control software from the database of the host computer 300 based on the received information, and transmits the optimum image formation control software to the image forming apparatus or an information processing apparatus (corresponding to, e.g., a personal computer shown in FIG. 13).

The image forming apparatus stores the received image formation control software in a HD or another memory in the apparatus body, and then utilizes the stored control software in control of the image formation.

The process of transmitting the ID number from the image forming apparatus to the managing server is carried out in accordance with a similar flow to that shown in FIG. 6 described above in connection with the first embodiment, and a description thereof is not repeated here.

(Third Embodiment)

As a third embodiment, control on both the user side and the distribution server side will be described below in more detail based on the features of the first and second embodiments.

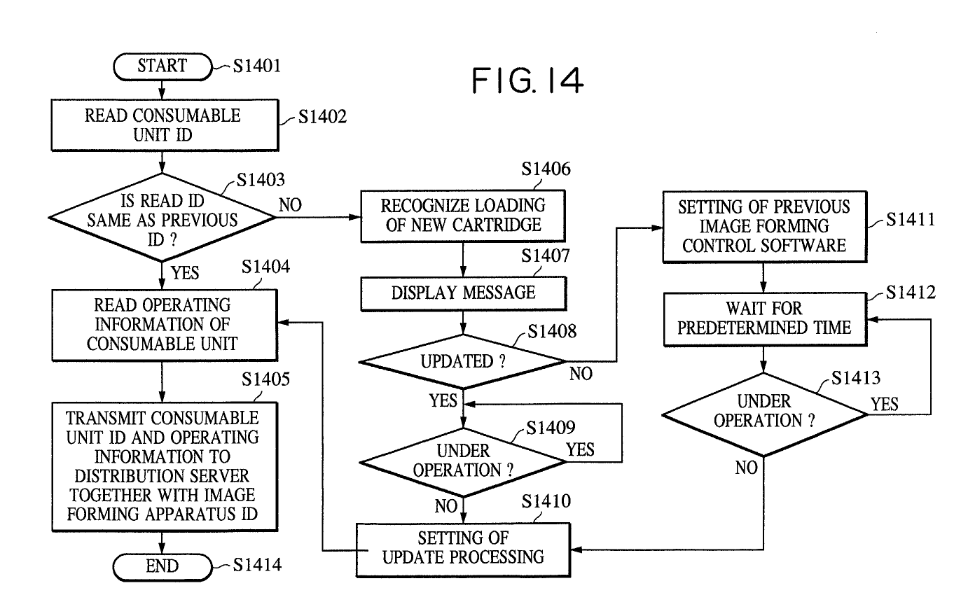

FIG. 14 shows control processing executed in external equipment, which is described above in the first embodiment with reference to FIG. 6 and is capable of communicating with a distribution server installed on the user side. Herein, the external equipment capable of communicating with the distribution server may be a body of an image forming apparatus or an information processing apparatus to which the body of the image forming apparatus is connected. As a matter of course, a similar arrangement is also applied to the control process shown in FIG. 6. Also, the processing of each step in FIG. 14 is realized by a CPU reading and executing control programs, which are stored in a nonvolatile storage means, such as a ROM or a hard disk, to execute the processing of FIG. 14.

First, the processing is started in step S1401. The start of the processing is actuated, for example, when a power source for the image forming apparatus is turned on from an off-state, or when inputting of an instruction to update the image formation control software via a control panel provided on the image forming apparatus or the information processing apparatus is recognized by the apparatus body, or when a process cartridge loaded in the image forming apparatus is replaced, or at the preserved predetermined timing.

Then, in step S1402, the CPU reads the ID number of a consumable unit. For example, when a rewritable nonvolatile memory (corresponding to 2000 in FIG. 3) is associated with the process cartridge, the ID number of a consumable unit is read from the memory. Also, when an instruction to input the ID number of the consumable unit is issued from the control panel of the image forming apparatus or the information processing apparatus, the apparatus serving as a main unit for executing the processing reads a signal corresponding to the input instruction.

Then, in step S1403, the CPU determines whether the ID number of the consumable unit read in step S1402 is the same as the previous one. The previous ID number is stored and held beforehand in a rewritable storage unit, such as the HD 309 (see FIG. 5), of the image forming apparatus. As an alternative, when the processing of step S1403 is executed by the information processing apparatus (e.g., the personal computer in FIG. 13), the determination is made based on the ID number of the consumable unit stored in a HD of the information processing apparatus.

If the determination result is Yes in step S1403, a process of reading the operating information of the image forming apparatus stored in the predetermined storage unit is executed. Incidentally, when the information processing apparatus executes the processing of step S1404, it acquires the operating information of the image forming apparatus stored in the predetermined storage unit via a communication line.

Then, in the processing of step S1405, the ID number (information) for identifying the image forming apparatus, and the ID number of the consumable unit and the operating information having been read in steps S1403 and S1404, respectively, are notified to the distribution server via a network. At that time, for example, the address of the distribution server as a destination may be stored in the image forming apparatus or the information processing beforehand. Also, the ID number (information) for identifying the image forming apparatus is acquired in a similar manner to the case of acquiring the operating information.

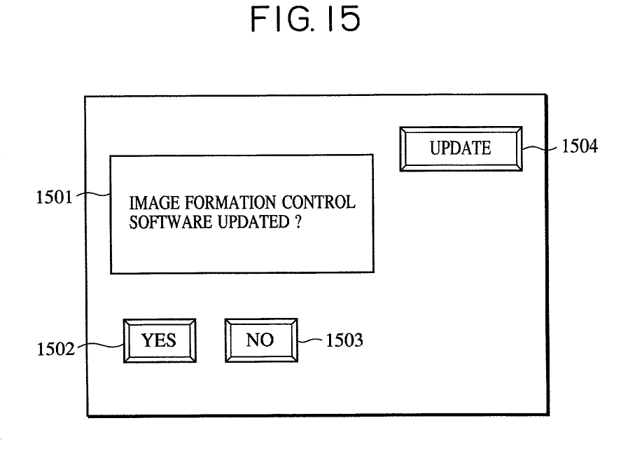

On the other hand, if the determination result is No in step S1403, loading of a new cartridge is recognized in step S1406. Then, in step S1407, the CPU executes control to display a message shown in FIG. 15 for prompting a user to make a decision on update of the image formation control software.

Subsequently, if the decision result is Yes in step S1408, the process control shifts to step S1409, and if the decision result is No, the process control shifts to step S1411. The Yes/No decision in step S1408 is confirmed by recognizing an instruction signal issued upon depressing of an instruction button 1502 or 1503 shown in FIG. 15. By thus displaying the message shown in FIG. 15, it is possible to recognize changes in the information of the consumable unit that is detachably loaded in the image forming apparatus, and to realize control for displaying the prompt to update the image formation control software at the proper timing in an efficient manner based on the recognized information. For example, when an urgent print output is required, the image formation control software can be distributed at a later point in time. Numeral 1503 in FIG. 15 is an instruction button enabling the image formation control software to be updated at any desired timing. When an instruction issued from depressing of the button 1503 is recognized by the image forming apparatus or the information processing apparatus, the flowchart of FIG. 6 or 14 is executed and the image formation control software can be updated at the timing convenient for the user.

In step S1409, the CPU determines whether the image forming apparatus is under operation. The term “under operation” used herein corresponds to the fact that the apparatus recognizes the presence of a print preservation already set to operate the image forming apparatus for executing the print processing.

Then, if it is determined in step S1409 that processing of print data to execute the print processing is completed, the process control shifts to step S1410. The determination result No in step S1409 corresponds to the fact that the image forming apparatus recognizes a pause in the print job, or that the image forming apparatus recognizes the completion of all the preserved jobs. As a modification, after receiving the image formation control software to update it (i.e., after executing the processing of steps S1404 and S1405 to receive the image formation control software from the distribution server), the CPU may determine whether the print processing is under execution (step S1409), and if not so, the CPU may start control for executing the processing to update the image formation control software. With that modification, the software can be updated at the more appropriate timing.

In step S1410, the CPU executes the processing for setting to update the image formation control software. Herein, the processing for update setting (or the setting of update processing) means control for externally obtaining the image formation control software via a communication line, turning on a flag indicating the execution of downloading (then turning off the flag at completion of the downloading), and monitoring the state of the flag to make an interrupt of the image forming operation or the execution of predetermined processing remain in a standby state during a period in which the flat is turned on.

On the other hand, if the decision result in step S1408 is No, the CPU executes in step S1411 the processing for setting to, for example, temporarily utilize the image formation control software, which has been employed before replacement by a new process cartridge, as an alternative control program for the image formation process. Herein, the image formation control software employed before new setting means the control software utilized when the previously employed consumable unit (cartridge) was still new. The processing of step S1411 is realized by storing the image formation control software before the update in the predetermined storage unit when the image formation control software is updated in accordance with the processing of FIGS. 6, 7 and 11 described above in the first and second embodiments.

Then, in step S1412, the CPU executes the processing to wait for a predetermined time (e.g., until a certain period of time lapses in a condition in which the print operation is not performed). In step S1413, the CPU executes the processing similar to that in step S1409. Specifically, if the decision result is No in step S1413, the process control shifts to step S1410. If the decision result is Yes in step S1413, the process control shifts to step S1410 after repeating the processing of step S1412 or waiting until a pause of the print job is recognized.

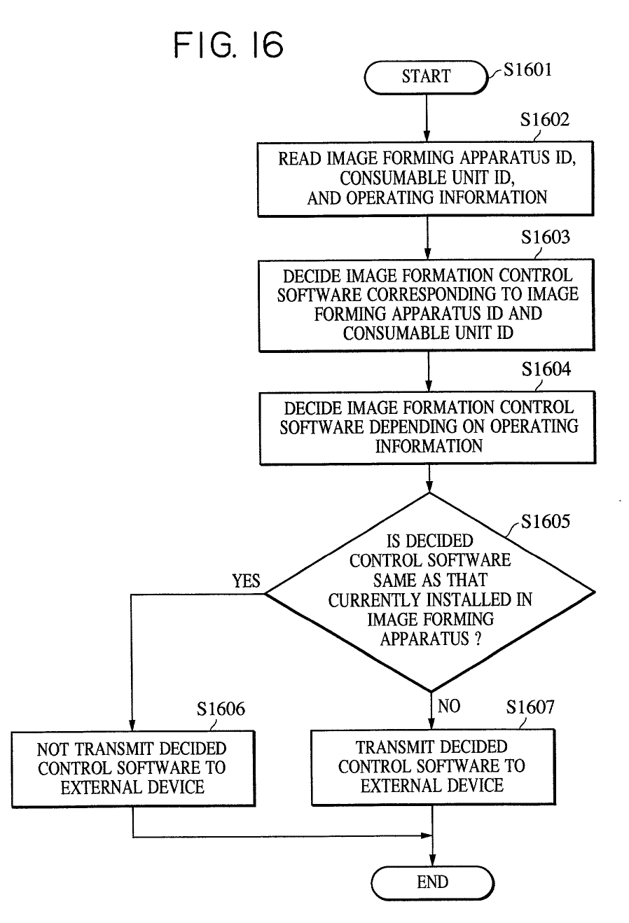

A description is now made of a flowchart of FIG. 16. The processing of the flowchart shown in FIG. 16 corresponds to the control processing executed in the distribution server and is to describe the flowcharts of FIGS. 7 and 11 in more detail, which have been described in the first and second embodiments. Note that the processing of each step in FIG. 16 is realized by a CPU, provided in the distribution server, reading and executing control programs, which are stored in a ROM or a hard disk.

First, the processing is started in step S1601. This processing means that distribution server is started up corresponding to the processing executed on the user side as described above with reference to FIGS. 6 and 14.

Then, in step S1602, the CPU reads the ID number of the image forming apparatus, the ID number of the consumable unit, and the operating information. For example, this step S1602 corresponds to the processing executed in response to reception of the ID number of the image forming apparatus, the ID number of the consumable unit, and the operating information which are transmitted via the network.

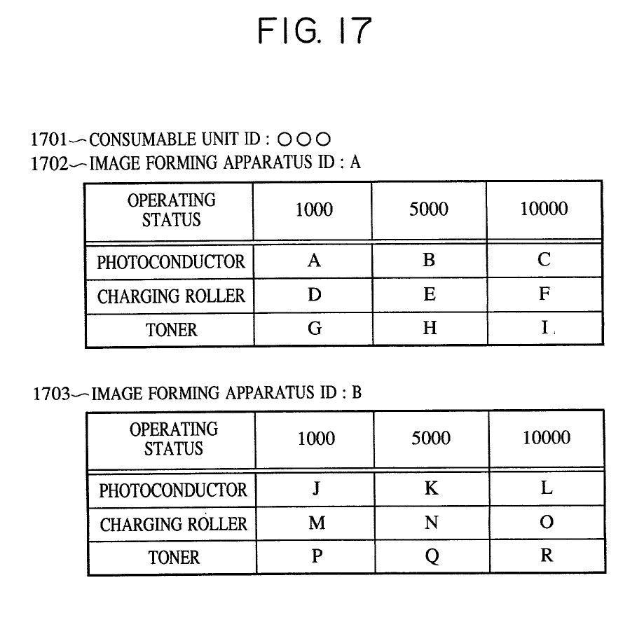

Then, in step S1603, based on the information read in step S1602, the optimum image formation control software is retrieved and decided by the distribution server corresponding to the ID number of the image forming apparatus and the ID number of the consumable unit. FIG. 17 shows one example of a table that is referred to by the distribution server when the optimum image formation control software is retrieved and decided in step S1603. To explain in more detail, in step S1603, the combination of 1701 and 1702 shown in FIG. 17 is first decided, by way of example, depending on the information received in step S1602. By preparing a database, such as shown in FIG. 17, in the distribution server, appropriate separate pieces of image formation control software can be distributed to even those image forming apparatuses which employ consumable units of the same type or the same production lot, but are of different types. Image forming apparatuses of different types are, e.g., those ones utilizing the same type of consumable units, but having different printing speeds. In other words, with the distribution server of this embodiment, if the types of image forming apparatuses differ from each other in spite of the consumable-unit information being the same, different appropriate pieces of image formation control software can be distributed to those the image forming apparatuses.

The table of FIG. 17 represents information stored in a predetermined nonvolatile storage means provided in the distribution server. As a matter of course, it is assumed that details of the optimum image formation control software decided based on the table of FIG. 17 is managed in a predetermined storage unit available by distribution server.

Then, in step S1604, the optimum image formation control software is decided depending on the operating information in combination with the image formation control software that has been decided in step S1603 corresponding to the ID number of the image forming apparatus and the ID number of the consumable unit. Specifically, the image formation control software corresponding to the operating status (number of prints output using the consumable unit) shown in FIG. 17 is decided. Note that details of step S1604 are similar to the processing described above with reference to the flowchart of FIG. 11 and hence are not described here.

In step S1605, the CPU determines whether the image formation control software currently utilized by the image forming apparatus under control is the same as that decided in step S1604. The determination in step S1605 is realized by including identifying information of the image formation control software, which is currently utilized by the image forming apparatus, in the information to be read in step S1602, or by managing the image formation control software, which has been installed in the image forming apparatus beforehand, on the distribution server side.

Subsequently, the processing of step S1606 or S1607 is executed in accordance with the determination result in step S1605.

Thus, by realizing the processing of the flowchart shown in FIG. 16, the distribution server is able to decide the image formation control software depending on the identifying information indicating the type of the image forming apparatus and the ID number of the consumable unit identifying the production lot number and type of the consumable unit, which are transmitted from the image forming apparatus or the information processing apparatus on the user side. Further, the flowchart of FIG. 16 makes it possible to achieve efficient distribution of the image formation control software depending on the identifying information of the image forming apparatus, the ID number of the consumable unit, and the operating information regarding the body of the image forming apparatus.

According to the present invention, as described above, optimum image formation control software depending on information of a consumable unit, which is detachably loaded in an image forming apparatus, can be supplied to the image forming apparatus.

Also, it is possible to provide a system for distributing image formation control software, which enables high-quality image formation to be always carried out regardless of the production lot and the operating status of the consumable unit.

Further, a system can be provided which is capable of updating optimum image formation control software at the timing efficient for replacement of each part of a consumable unit that is detachably loaded in the body of the image forming apparatus.

Still further, a system can be provided which is capable of updating optimum image formation control software depending on the type of the image forming apparatus and the type of the consumable unit that is detachably loaded in the image forming apparatus.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An information processing apparatus for distributing image formation control software via a network, comprising:
receiving means for receiving consumable-unit information regarding a consumable unit, which is detachably loaded in an image forming apparatus, from external equipment capable of communicating data via the network; and
software distributing means for distributing image formation control software to said external equipment depending on the consumable-unit information via the network.

2. An information processing apparatus according to claim 1, further comprising:
storage means for storing plural kinds of image formation control software depending on the consumable-unit information received by said receiving means; and
deciding means for retrieving and deciding predetermined image formation control software depending on the consumable-unit information received by said receiving means,
wherein said software distributing means distributes the predetermined image formation control software decided by said deciding means to said external equipment via the network.

3. An information processing apparatus according to claim 2, wherein the consumable-unit information is information for specifying a production lot number of said consumable unit; said storage means stores optimum image formation control software corresponding to the production lot number; said deciding means retrieves and decides the image formation control software corresponding to the production lot number based on the consumable-unit information; and said software distributing means distributes the image formation control software decided by said deciding means corresponding to the production lot number to said external equipment via the network.

4. An information processing apparatus according to claim 3, wherein said storage means stores optimum image formation control software depending on combinations of production lots of respective parts making up said consumable unit corresponding to the consumable-unit information; said deciding means retrieves and decides the image formation control software corresponding to a combination of the production lots of said consumable unit based on the consumable-unit information; and said software distributing means distributes the image formation control software decided by said deciding means corresponding to the combination of the production lots to said external equipment via the network.

5. An information processing apparatus according to claim 2, further comprising:
collecting means for collecting operating information of said image forming apparatus or said consumable unit via said network; and
selecting means for selecting, from among plural pieces of image formation control software stored in said storage means and corresponding to a predetermined production lot number, predetermined image formation control software depending on the operating information collected by said collecting means,
wherein said software distributing means distributes the predetermined image formation control software selected by said selecting means via the network.

6. An information processing apparatus according to claim 1, wherein said consumable unit includes at least a photoconductor, a charging roller, or a toner used in said image forming apparatus.

7. An information processing apparatus according to claim 1, further comprising:
recognizing means for recognizing that said consumable unit is a photoconductor and the consumable-unit information is a production lot number of said photoconductor,
wherein said software distributing means distributes, via the network, software for instructing said image forming apparatus to control a light amount irradiated to said photoconductor.

8. An information processing apparatus according to claim 1, wherein said receiving means further receives image forming apparatus identifying information for identifying said image forming apparatus; said deciding means decides predetermined image formation control software depending on the image forming apparatus identifying information and the consumable-unit information; and the consumable-unit information contains information for specifying a type of said consumable unit.

9. An information processing apparatus comprising:
transmitting means for transmitting consumable-unit information regarding a consumable unit, which is detachably loaded in an image forming apparatus, to an image-formation control software distribution server capable of communicating data via a network; and
receiving means for receiving, via the network, image formation control software decided by and transmitted from said distribution server depending on the consumable-unit information.

10. An information processing apparatus according to claim 9, further comprising:
recognizing means for recognizing the consumable-unit information regarding the consumable unit detachably loaded in said image forming apparatus;
determining means for determining whether the consumable-unit information recognized by said recognizing means is changed from consumable-unit information stored in a predetermined storage unit; and
control means for making control to display a prompt for updating the image formation control software when said determining means determines that the consumable-unit information is changed.

11. An information processing apparatus according to claim 9 or 10, further comprising:
setting control means for executing installation of the image formation control software received by said receiving means;
print processing means for executing print processing on a predetermined recording medium; and
determining means for determining whether the print processing is being executed by said print processing means,
wherein said setting control means executes installation of the image formation control software in response to a determination result made by said determining means.

12. An image-formation control software distributing system made up of a first information processing apparatus for distributing image formation control software via a network, and a second information processing apparatus capable of executing communication with said first information processing apparatus, the system comprising:
receiving means for receiving consumable-unit information regarding a consumable unit, which is detachably loaded in an image forming apparatus, from said second information processing apparatus capable of communicating data via the network; and
software distributing means for distributing image formation control software to said first information processing apparatus depending on the consumable-unit information via the network.

13. An information processing method for distributing image formation control software via a network, comprising the steps of:
a receiving step of receiving consumable-unit information regarding a consumable unit, which is detachably loaded in an image forming apparatus, from external equipment capable of communicating data via the network; and
a software distributing step of distributing image formation control software to said external equipment depending on the consumable-unit information via the network.

14. An information processing method according to claim 13, further comprising:
a storage control step of storing plural kinds of image formation control software depending on the consumable-unit information received by said receiving means; and
a deciding step of retrieving and deciding predetermined image formation control software depending on the consumable-unit information received in said receiving step,
wherein said software distributing step distributes the predetermined image formation control software decided in said deciding step to said external equipment via the network.

15. An information processing method according to claim 14, wherein the consumable-unit information is information for specifying a production lot number of said consumable unit; said storage control step stores optimum image formation control software corresponding to the production lot number; said deciding step retrieves and decides the image formation control software corresponding to the production lot number based on the consumable-unit information; and said software distributing step distributes the image formation control software decided in said deciding step corresponding to the production lot number to said external equipment via the network.

16. An information processing method according to claim 15, wherein said storage control step stores optimum image formation control software depending on combinations of production lots of respective parts making up said consumable unit corresponding to the consumable-unit information; said deciding step retrieves and decides the image formation control software corresponding to a combination of the production lots of said consumable unit based on the consumable-unit information; and said software distributing step distributes the image formation control software decided in said deciding step corresponding to the combination of the production lots to said external equipment via the network.

17. An information processing method according to claim 14, further comprising:
a collecting step of collecting operating information of said image forming apparatus or said consumable unit via said network; and
a selecting step for selecting, from among plural pieces of image formation control software stored in said storage control step and corresponding to a predetermined production lot number, predetermined image formation control software depending on the operating information collected in said collecting step,
wherein said software distributing step distributes the predetermined image formation control software selected in said selecting step via the network.

18. An information processing method according to claim 13, wherein said consumable unit includes at least a photoconductor, a charging roller, or a toner used in said image forming apparatus.

19. An information processing method according to claim 13, further comprising:
a recognizing step of recognizing that said consumable unit is a photoconductor and the consumable-unit information is a production lot number of said photoconductor,
wherein said software distributing step distributes, via the network, software for instructing said image forming apparatus to control a light amount irradiated to said photoconductor.

20. An information processing method according to claim 13, wherein said receiving step further receives image forming apparatus identifying information for identifying said image forming apparatus; said deciding step decides predetermined image formation control software depending on the image forming apparatus identifying information and the consumable-unit information; and the consumable-unit information contains information for specifying a type of said consumable unit.

21. An information processing method comprising:
a transmitting step of transmitting consumable-unit information regarding a consumable unit, which is detachably loaded in an image forming apparatus, to an image-formation control software distribution server capable of communicating data via a network; and
a receiving step of receiving, via the network, image formation control software decided by and transmitted from said distribution server depending on the consumable-unit information.

22. An information processing method according to claim 21, further comprising:
a recognizing step of recognizing the consumable-unit information regarding the consumable unit detachably loaded in said image forming apparatus;
a determining step of determining whether the consumable-unit information recognized in said recognizing step is changed from consumable-unit information stored in a predetermined storage unit; and
a control step of making control to display a prompt for updating the image formation control software when said determining step determines that the consumable-unit information is changed.

23. An information processing method according to claim 21 or 22, further comprising:
a setting control step of executing installation of the image formation control software received in said receiving step;
a print processing step of executing print processing on a predetermined recording medium; and
a determining step of determining whether the print processing is being executed in said print processing step,
wherein said setting control step executes installation of the image formation control software in response to a determination result made in said determining step.

24. An information processing method for use in an image-formation control software distributing system made up of a first information processing apparatus for distributing image formation control software via a network, and a second information processing apparatus capable of executing communication with said first information processing apparatus, the method comprising the steps of:
a receiving step of receiving consumable-unit information regarding a consumable unit, which is detachably loaded in an image forming apparatus, from said second information processing apparatus capable of communicating data via the network; and
a software distributing step of distributing image formation control software to said first information processing apparatus depending on the consumable-unit information via the network.

25. A program executed by an information processing apparatus for distributing image formation control software via a network, the program comprising the steps of:
a receiving step of receiving consumable-unit information regarding a consumable unit, which is detachably loaded in an image forming apparatus, from external equipment capable of communicating data via the network; and
a software distributing step of distributing image formation control software to said external equipment depending on the consumable-unit information via the network.

26. A program according to claim 25, further comprising:
a storage control step of storing plural kinds of image formation control software depending on the consumable-unit information received by said receiving means; and
a deciding step of retrieving and deciding predetermined image formation control software depending on the consumable-unit information received in said receiving step,
wherein said software distributing step distributes the predetermined image formation control software decided in said deciding step to said external equipment via the network.

27. A program according to claim 26, wherein the consumable-unit information is information for specifying a production lot number of said consumable unit; said storage control step stores optimum image formation control software corresponding to the production lot number; said deciding step retrieves and decides the image formation control software corresponding to the production lot number based on the consumable-unit information; and said software distributing step distributes the image formation control software decided in said deciding step corresponding to the production lot number to said external equipment via the network.

28. A program according to claim 27, wherein said storage control step stores optimum image formation control software depending on combinations of production lots of respective parts making up said consumable unit corresponding to the consumable-unit information; said deciding step retrieves and decides the image formation control software corresponding to a combination of the production lots of said consumable unit based on the consumable-unit information; and said software distributing step distributes the image formation control software decided in said deciding step corresponding to the combination of the production lots to said external equipment via the network.

29. A program according to claim 26, further comprising:
a collecting step of collecting operating information of said image forming apparatus or said consumable unit via said network; and
a selecting step for selecting, from among plural pieces of image formation control software stored in said storage control step and corresponding to a predetermined production lot number, predetermined image formation control software depending on the operating information collected in said collecting step,
wherein said software distributing step distributes the predetermined image formation control software selected in said selecting step via the network.

30. A program according to claim 25, wherein said consumable unit includes at least a photoconductor, a charging roller, or a toner used in said image forming apparatus.

31. A program according to claim 25, further comprising:
a recognizing step of recognizing that said consumable unit is a photoconductor and the consumable-unit information is a production lot number of said photoconductor,
wherein said software distributing step distributes, via the network, software for instructing said image forming apparatus to control a light amount irradiated to said photoconductor.

32. A program according to claim 25, wherein said receiving step further receives image forming apparatus identifying information for identifying said image forming apparatus; said deciding step decides predetermined image formation control software depending on the image forming apparatus identifying information and the consumable-unit information; and the consumable-unit information contains information for specifying a type of said consumable unit.

33. A program for instructing an information processing apparatus to execute the steps of:
a transmitting step of transmitting consumable-unit information regarding a consumable unit, which is detachably loaded in an image forming apparatus, to an image-formation control software distribution server capable of communicating data via a network; and
a receiving step of receiving, via the network, image formation control software decided by and transmitted from said distribution server depending on the consumable-unit information.

34. A program according to claim 33, the program instructing said information processing apparatus to further execute the steps of:
a recognizing step of recognizing the consumable-unit information regarding the consumable unit detachably loaded in said image forming apparatus;
a determining step of determining whether the consumable-unit information recognized in said recognizing step is changed from consumable-unit information stored in a predetermined storage unit; and
a control step of making control to display a prompt for updating the image formation control software when said determining step determines that the consumable-unit information is changed.

35. A program according to claim 33 or 34, the program instructing said information processing apparatus to further execute the steps of:
a setting control step of executing installation of the image formation control software received in said receiving step;
a print processing step of executing print processing on a predetermined recording medium; and
a determining step of determining whether the print processing is being executed in said print processing step,
wherein said setting control step executes installation of the image formation control software in response to a determination result made in said determining step.

36. A program executed by an image-formation control software distributing system made up of a first information processing apparatus for distributing image formation control software via a network, and a second information processing apparatus capable of executing communication with said first information processing apparatus, the program comprising the steps of:
a receiving step of receiving consumable-unit information regarding a consumable unit, which is detachably loaded in an image forming apparatus, from said second information processing apparatus capable of communicating data via the network; and
a software distributing step of distributing image formation control software to said first information processing apparatus depending on the consumable-unit information via the network.

37. A storage medium product storing, in computer-readable form, program code for distributing image formation control software via a network, the program code comprising the steps of:
a receiving step of receiving consumable-unit information regarding a consumable unit, which is detachably loaded in an image forming apparatus, from external equipment capable of communicating data via the network; and
a software distributing step of distributing image formation control software to said external equipment depending on the consumable-unit information via the network.

38. A storage medium product storing program code in computer-readable form, the program code comprising the steps of:
a transmitting step of transmitting consumable-unit information regarding a consumable unit, which is detachably loaded in an image forming apparatus, to an image-formation control software distribution server capable of communicating data via a network; and
a receiving step of receiving, via the network, image formation control software decided by and transmitted from said distribution server depending on the consumable-unit information.

39. A storage medium product storing, in computer-readable form, program code for executing an information processing method by an image-formation control software distributing system made up of a first information processing apparatus for distributing image formation control software via a network, and a second information processing apparatus capable of executing communication with said first information processing apparatus, the program code comprising the steps of:
a receiving step of receiving consumable-unit information regarding a consumable unit, which is detachably loaded in an image forming apparatus, from said second information processing apparatus capable of communicating data via the network; and
a software distributing step of distributing image formation control software to said first information processing apparatus depending on the consumable-unit information via the network.
